(19) United States
(12) Patent Application Publication
(10) Pub. No.: US 2007/0079672 A1
(43) Pub. Date: Apr. 12, 2007

(54) Screw feeder

(75) Inventors: Daniel Bone, Durham (GB); Phillip Kelvin Thompson, Durham (GB)

Correspondence Address: Bruce S Shapiro;The Black & Decker Corporation, 701 E Joppa Rd - TW 199, Towson, MD, 21286, US

(73) Assignee: BLACK & DECKER INC., NEWARK, DE (US)

(21) Appl. No.: 10/554,939

(22) PCT Filed: Apr. 30, 2004
(86) PCT No.: PCT/GB04/01889

§ 371 Date: Dec. 11, 2006

(30) Foreign Application Priority Data
Apr. 30, 2003 (GB) 0309787.0

(51) Int. Cl. B25B 23/00; B25B 17/00

(52) U.S. Cl. 81/57.37; 81/435

(57) ABSTRACT

A screw feeder (10) is disclosed which can be mounted to a screwdriver (12) for holding a screw (32) in position relative to a screwdriver bit (16) of the screwdriver (12) to enable insertion of the screw (12) into a workpiece adjacent the holding portion (30). The screw feeder (10) has a holding portion (30) and a feeder portion (34) adjacent the holding portion (30). The holding portion (30) can releasably hold a first screw (32) in position relative to the screwdriver bit (16) and receive a distal end of the screwdriver bit (16) to enable the screwdriver bit (16) to insert the first screw (32) into the workpiece. The feeder portion (34) is arranged adjacent the holding portion (30) and is adapted to receive a plurality of second screws (36) and to sequentially feed each of the second screws (36) into the holding portion (30) in response to retraction of the screwdriver bit (16) from the holding portion.

The present invention relates to a screw feeder adapted to be mounted to a screwdriver, and relates particularly, but not exclusively, to a screw feeder adapted to be mounted to an electrically powered screwdriver.

When using a screwdriver to secure a number of screws sequentially into a workpiece it is desirable to hold each screw in a desired orientation and position relative to the screwdriver bit and the workpiece.

A known screw feeder comprises a body portion which can be fitted to an electrically powered screwdriver. The body portion has a feeder head and a separate screw guide which can be connected to the body portion. A flexible belt is provided which has a number of evenly spaced slots along its length into which screws are inserted. Screws are pushed through the slots and secured to the belt by a collar portion located around each slot. Before operation of the screw feeder, the screw guide is connected to the screw feeder and the belt, holding one or more screws, is fed through the screw guide and then over the feeder head until the longitudinal axis of the first screw is coaxial with the shaft of the screwdriver bit.

In use, screws are fed sequentially to the feeder head. Once a screw has been inserted into a workpiece and has passed through the slot in the belt, the belt advances to bring the next screw to a holding position, ready for screwing. The belt is fed through the screw guide and feeder head until the desired number of screws have been used or the belt is empty.

The prior art screw feeder described above suffers from the disadvantage that the operator is required to manually insert the screws into the strip before use, and the strip then has to be fed through the screw guide and over the feeder head. Both of these operations require a degree of manual dexterity and can prove to be relatively time consuming. Furthermore, the arrangement of a separate strip, screw guide and screw feeder head is relatively complicated, requiring several components to be connected together. This increases the cost of production of the screw feeder, while also presenting the risk of the screw feeder jamming in use. Also, such devices generally need to be adjusted to accommodate screws of different lengths.

Preferred embodiments of the present invention seek to overcome the above disadvantages of the prior art.

According to an aspect of the present invention, there is provided a screw feeder adapted to be mounted to a screwdriver and to hold screws in position relative to a screwdriver bit of the screwdriver to assist insertion of the screws into a workpiece, the screw feeder comprising:- a magazine for containing a plurality of screws therewithin, the magazine including a first biasing means to act upon screws therewithin; a holding portion in communication with the magazine, the holding portion for releasably retaining screws passed thereto from the magazine and for releasing the screws releaseably retained therewithin under action of insertion of a screwdriver bit into the holding portion in order to drive a screw held within the holding portion into a workpiece; wherein the holding portion comprises at least one jaw pivotable about a longitudinal axis, the at least one jaw arranged to releasably restrain a screw passed to the holding portion by the magazine under action of the first biasing means, the holding portion including a channel within which channel a restrained screw is held until advanced out of the holding portion under action of the screwdriver bit inserted into the holding portion via the channel and into driving engagement with the screw so restrained; and wherein the magazine includes a central slot along which central slot the screws pass under the action of the first biasing means, the central slot being aligned with the longitudinal axis of the pivotable at least one jaw so that, on passing from the magazine to the holding portion, the screws maintain the same alignment relative to both the central slot and the longitudinal axis; and wherein screws from the magazine are fed in succession to the holding portion under action of the first biasing means and releasably restrained within the holding portion following retraction of said screwdriver bit from said holding portion.

By arranging a magazine adjacent the holding portion, this provides the advantage of facilitating feeding of one of said second screws to the holding portion after a first screw has been inserted into a workpiece. This in turn provides the advantage of removing the need for screws to be attached to a belt, which makes the operation of feeding screws both easier and less time consuming. This further allows for the screws to be held within the magazine in the same orientation as they are held within the holding portion. The present invention also has the advantage of being less complicated and expensive to produce, in that the strip does not have to be fed into the screw feeder and less components need to be fitted together.

Preferably, said holding portion comprises a plurality of holding members defining a holding recess, wherein said holding members are adapted to be urged apart by a movement of said first screw into a workpiece to release said first screw from said holding recess.

The holding portion may comprise one, or a plurality of, jaws.

The screw feeder may further comprise first biasing means for urging said holding members together, wherein said holding members are adapted to feed a single said second screw into said holding recess in response to retraction of the screwdriver bit therefrom.

Said holding members may define at least one cam surface such that axial movement of a head of a said first screw against the or each said cam surface causes said holding members to be urged apart.

The screw feeder may further comprise guide means adjacent said holding portion.

This provides the advantage of maintaining the first screw in the desired orientation as it leaves the holding portion.

The feeder portion may further comprise at least one slot for feeding one or more of said second screws towards said holding portion.

This provides the advantage of providing a simple way of maintaining each screw in the correct position and orientation.

At least one said slot may comprise a respective screw head receiving portion.

This provides the advantage of ensuring that the screws are correctly aligned before and during entry into the holding portion.

The feeder portion may further comprise second biasing means for urging one or more said second screws towards said holding portion.

This provides the advantage of preventing screws from falling out of the feeder portion, thereby enabling the screw feeder to be used in any orientation, even upside down. The second biasing means also assists in feeding the next screw into the holding portion after a previous screw has been released from the holding portion.

The screw feeder may further comprise a mounting portion for mounting said screw feeder to a screwdriver.

The screw feeder may further comprise adjustment means for enabling adjustment of the separation of said mounting portion from said holding portion and said feeder portion.

This provides the advantage of enabling the screwdriver bit to be moved relative to the workpiece in response to movement of a screw into the workpiece.

Said adjustment means may comprise at least one telescopic arm.

Said adjustment means may further comprise third biasing means for urging said mounting portion away from said holding portion and said feeder portion.

The orientation of said holding portion and/or said feeder portion may be adjustable relative to said mounting portion.

Preferably screws are passed from the magazine to the holding portion in a direction which is orthogonal to the longitudinal axis.

Additionally the screws held within the magazine are not coupled to one another.

Preferably the slot within the magazine includes a screw head receiving portion to permit insertion of screws into the slot only in one orientation.

According to another aspect of the present invention, there is provided a power tool comprising:-

a body;

a screwdriver bit mounted to said body; and

a screw feeder as defined above.

An embodiment of the present invention will now be described, by way of example only and not in any limitative sense, with reference to the following drawings, in which:-

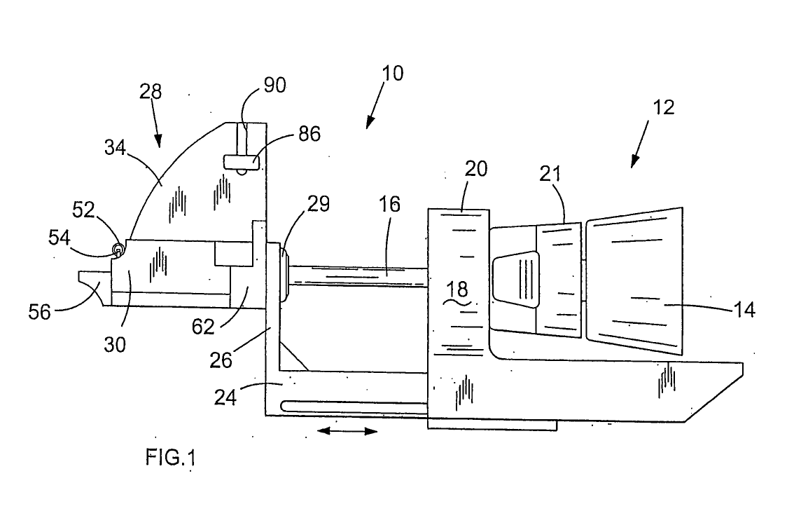

FIG. 1 shows a side elevation of a screw feeder embodying the present invention and attached to an electrically powered screwdriver;

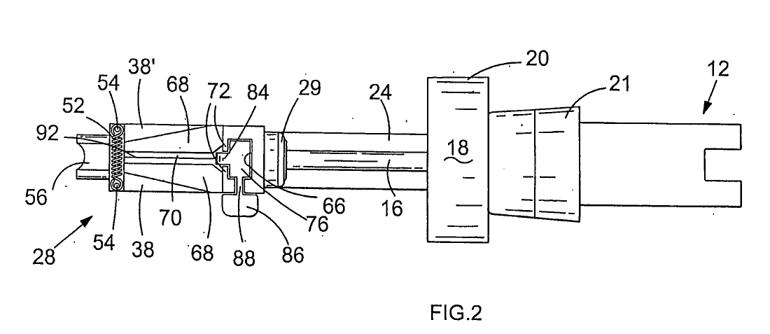

FIG. 2 shows a plan view of the screw feeder of FIG. 1;

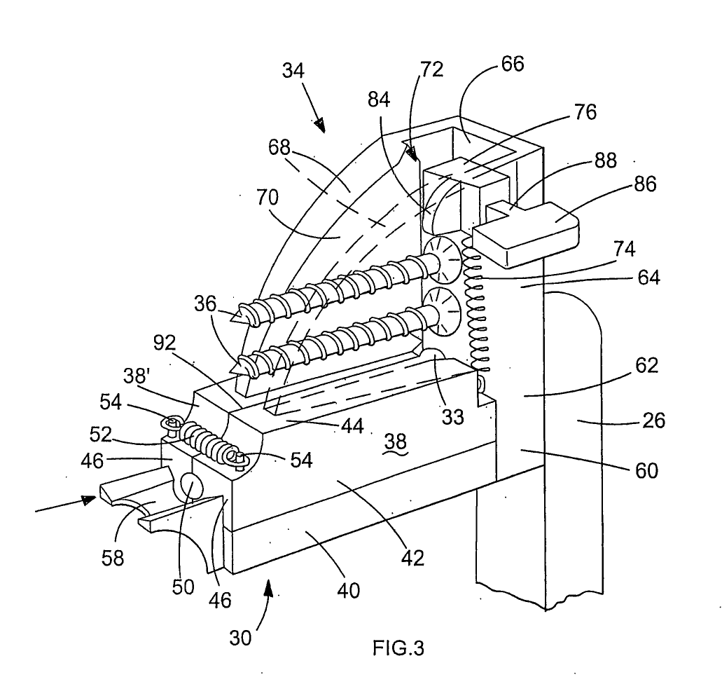

FIG. 3 shows a detailed perspective view of a holding portion and a feeder portion of the screw feeder of FIG. 1.

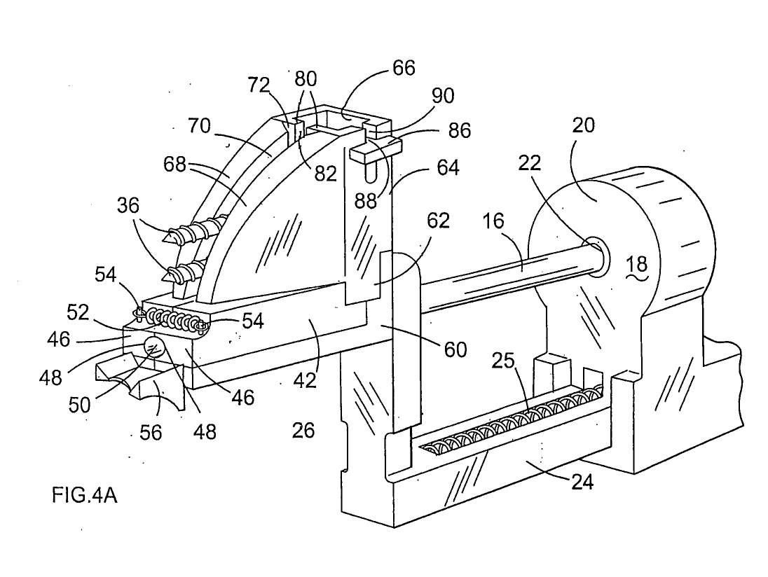

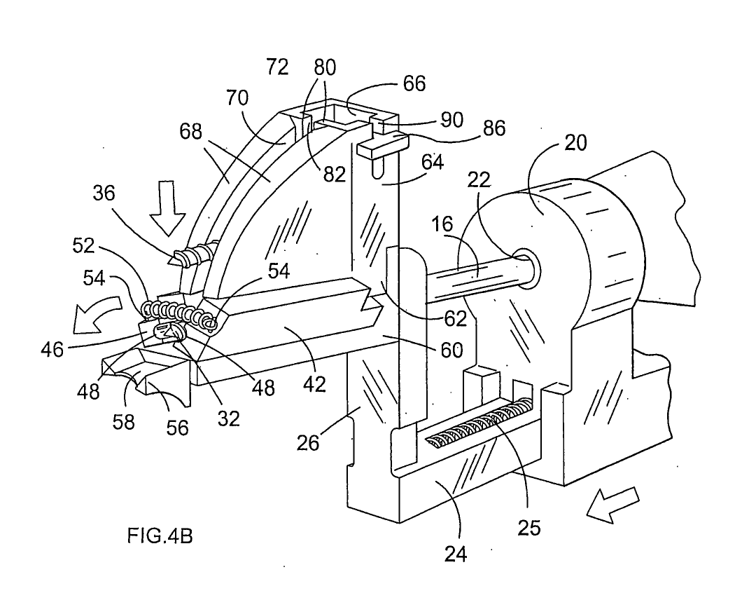

FIG. 4A shows a perspective view of the screw feeder of FIG. 1 prior to a screwing operation;

FIG. 4B shows the screw feeder and the screwdriver of FIG. 4A during a screwing operation;

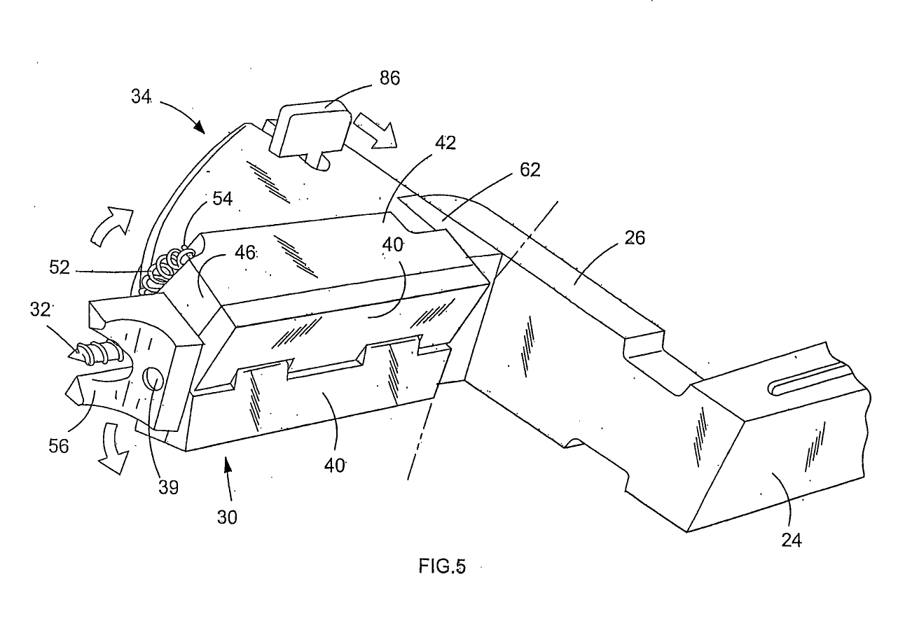

FIG. 5 shows a view from below of the screw feeder and the screwdriver of FIG. 4B; and

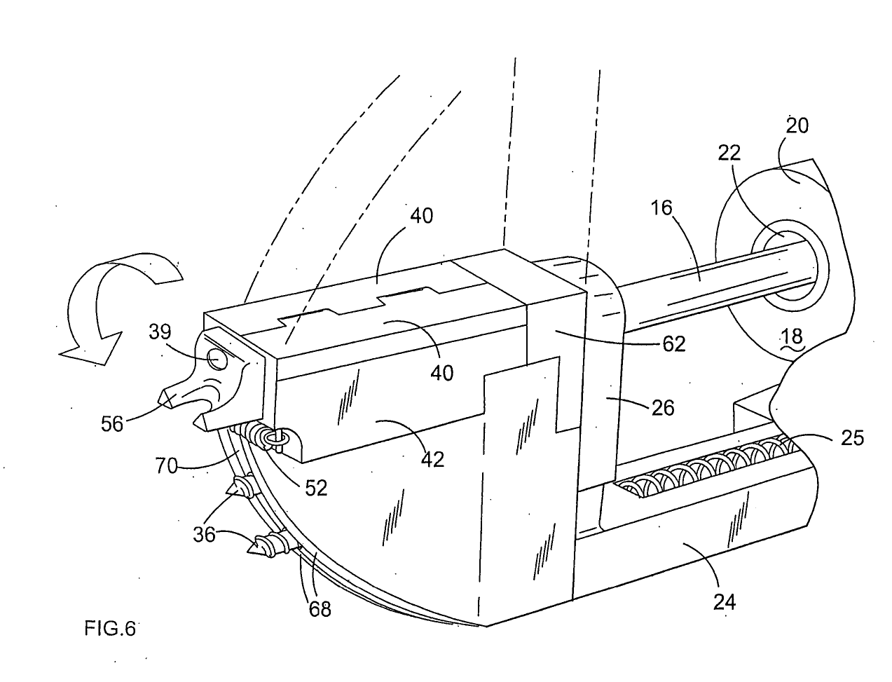

FIG. 6 illustrates how the orientation of the screw feeder portion can be adjusted relative to a mounting portion.

Referring to FIGS. 1, 2, 4A, 4B, 4 and 6, a screw feeder 10 embodying the present invention is shown secured to an electrically powered screwdriver 12. The screwdriver 12 has a screwdriver body 14 supporting a screwdriver bit 16. The screw feeder 10 has a mounting portion 18 having a generally L-shaped mounting bracket 20 and a connector 21 which can be mounted onto the screwdriver body 14 to support the screw feeder 10 on the screwdriver 12. The mounting bracket 20 is provided with an aperture 22 through which the screwdriver bit 16 extends when the screw feeder 10 is mounted to the screwdriver 12.

The mounting portion 18 also includes a telescopic arm 24, a first end of which is slidingly received in the mounting bracket 20 and is urged outwardly of the mounting bracket 20 by a compression spring 25. A support arm 26 extends from a second end of the telescopic arm 24 and generally at right angles to the telescopic arm 26, and rotatably supports a head portion 28 of the screw feeder 10. The head portion 28 has an aperture (not shown) for receiving the screwdriver bit 16, and is secured to the support arm 26 by means of a spigot 29. This allows free rotation of the head portion 28 relative to the support arm 26. The head portion 28 includes a holding portion 30, for holding a first screw 32 in a desired position and orientation relative to the screwdriver bit 16, and a feeder portion in this example magazine 34 adjacent the holding portion 30 for sequentially feeding a plurality of second screws 36 to the holding portion 30.

Referring now to FIGS. 3 to 6, the holding portion, in this example, 30 consists of first and second holding members, or jaws, 38, 38′ which can be pivoted about a pivot pin 39, itself defining a longitudinal axis, against the action of spring 52 between an open position and a closed position. Each of the holding members 38, 38′ has a base 40, a side wall 42, a top 44, a front wall 46 and a rear wall (not shown), and have oppositely-arranged recesses (not shown) along their axial lengths which define between them a holding recess (not shown) in which a first screw 32 can be received. The holding portion 30 could, however, be formed from only one pivoting jaw member 38, as appreciated by those skilled in the art.

The front walls 46 of the jaws 38, 38′ each have a generally semi-circular notch 48, the notches 48 between them defining an aperture 50 through which the first screw 32, located in the holding recess, can be guided into a workpiece (not shown) by the screwdriver bit 16 as shown in FIG. 4B. Internal surfaces of the holding recess have respective inclined cam surfaces (not shown) which cooperate with the head of the first screw 32, such that axial movement of the head of the screw 32 against the cam surfaces causes the jaws 38, 38′ to pivot about pivot pin 39 and its longitudinal axis to be urged apart. This allows the first screw 32 to be released from the holding portion 30 into the workpiece, while at the same time allowing a second screw 36 to be fed into the holding portion 30 from the magazine 34 upon retraction of the screwdriver bit 16, in a manner described in greater detail below. A screw guide 56 having a curved surface 58 is mounted on a first end of the pivot pin 39 adjacent aperture 50 of the holding portion 30. The screw guide 56 maintains the first screw 32 and subsequent screws in the correct orientation as each of them leaves the holding portion 30 and enters a workpiece. The screw guide also visually defines the point at which the screw enters the workpiece.

The rear walls of each jaw 38,38′ define an aperture (not shown) which enables the screwdriver bit 16 to enter the holding recess. The spring 52 is attached by means of hooks 54 to the exterior of the front walls 46 of each of the holding members 38, 38 to urge the jaws 38, 38′ together.

The magazine 34 has a support portion 60 (FIGS. 4A and 4B) which is mounted to a second end of the pivot pin 39. The support portion 60 takes the form of a block 62 having an aperture (not shown) which can receive the shaft of the screwdriver bit 16 and arranged coaxially with the holding recess defined by jaws 38, 38′. An upper part 64 of the support portion 60 defines a generally u-shaped channel 66, and a pair of generally quarter-circular parallel projecting walls 68 extend away from the upper part 64 of the magazine 34 and define between them a slot 70 for receiving a series of second screws 36 stacked one on top of the other. The slot 70 includes a screw head receiving portion 72 in which the head of each second screw 36 can slide transversely to locate the screws 36 in position above the holding recess. The screw head receiving portion 72 communicates with the u-shaped channel 66 and ensures that the or each second screw 36 is correctly aligned before and during entry into the holding portion 30. It will be noted that the screws 36 held within the magazine 34 are discretely restrained, that is no one screw is coupled to any other screw. Also the receiving portion 72 permits insertion of screws 36 into the slot 70 of the magazine 34 only in one orientation.

A spring 74 is disposed within the u-shaped channel 66 and urges a stop member 76, which is slidably received in the u-shaped channel 66, downwards in the u-shaped channel 66 as shown in FIG. 3 towards the holding members 38, 38′, the opposite end of spring 74 being connected to block 62 of support portion 60. A pair of protrusions 80 define an elongate gap 82 between the u-shaped channel 66 and the screw head receiving portion 72, and the stop member 76 has a projection 84 which extends through the gap 82 so that the projection 84 projects into the screw head receiving portion 72 to urge each screw 36 towards the jaws 38, 38′ and prevent each second screw 36 from falling out of the slot 70 when the screw feeder 10 is used in an upside down orientation. The stop member 76 also has a grip portion 86 which can be used to lift the stop member 76 in and out of the u-shaped channel 66 to enable the slot 70 to be re-filled with screws 36. The grip portion 86 is connected to the stop member 76 by a connector arm 88 and is locatable in a guide slot 90.

To load each second screw 36 into the slot 70, a user can take hold of the grip portion 86 and pull the stop member 76 against the returning force of the spring 74 out of the u-shaped channel 66. A number of screws 36 can then be inserted into the slot 70 such that their heads are received in the screw head receiving portion 72 and the shafts of the screws 36 lie in the slot 70 between the projecting walls 68, as shown in FIG. 4A. To aid loading of the screws, the edges formed between slot 70 and curved projecting walls 68 assist in guiding each screw head to cooperate with the screw head receiving portion 72. Once the screws 36 have been inserted into the slot 70 the stop member 76 can be replaced in the u-shaped channel 66 with the projection 84 resting on the head of the last of the screws 36. The spring 74 then acts on the stop member 76 to prevent it slipping out of the u-shaped channel 66 and at the same time holds the screws 36 in the slot 70. The spring 74 also urges the screws 36 towards the holding portion 30 such that one of the screws 36 can be fed into the holding recess when the jaws 38, 38′ are in the open position, as shown in FIGS. 4B and 5.

To initially load screws into the screw feeder 10, the stop member 76 is removed from the u-shaped channel 66 as described above and screws 36 inserted into the slot 70. The stop member 76 is then replaced to retain the screws 36 in the feeder portion 34. The lowermost of the screws 36 is disposed directly adjacent the tops 44 of the jaws 38, 38′. To feed the first screw 32 into the holding recess the screwdriver bit 16 is advanced through the relevant apertures into the holding recess, as a result of which the screwdriver bit 16 bears against the cam surfaces on the inner surfaces of the front walls 46 of the jaws 38, 38′. These cam surfaces taper inwardly towards the aperture 50 and, as the bit 16 is advanced through the aperture 50, the jaws 38,38′ are urged apart about pivot pin 39 against the force of spring 52.

The tops 44 of the holding members form a pair of receiving jaws 92 which separate in the open position to enable a first screw 32 to be partially fed into the holding recess as shown in FIGS. 4B and 5. However, the first screw 32 cannot be fully inserted into the holding recess, since the recess is occupied by screwdriver bit 16. The receiving jaws 92 are sized and shaped such that they are brought together in the closed position when the first screw 32 is in the holding recess such that the second screws 36 in the slot 70 of the feeder portion 34 are prevented from entering the holding recess.

As explained above, axial displacement of the screwdriver bit 16 to urge the jaws 38, 38′ apart allows a first screw 32 to be partially fed into the holding recess. The first screw 32 rests on top of the screwdriver bit 16 and as the bit 16 is withdrawn from the holding recess, the jaws 38,38′ are urged towards the closed position by the spring 52 and urge the first screw 32 downwards into the holding recess.

When the screwdriver bit 16 is fully withdrawn from the holding recess, the first screw 32 then drops into a holding position generally coaxial with the screwdriver bit 16, in which it is ready for engagement with the head of the screwdriver bit 16. The screwdriver bit 16 can be advanced again into the holding recess, but this time engages the head of the first screw 32 to urge the screw 32 into a workpiece. Advancing the bit 16 towards the workpiece forces the first screw 32 out of the holding recess through the aperture 50 and, as the head of the first screw 32 passes over the cam surfaces defined by jaws 38, 38′, the jaws 38, 38′ are moved into the open position. In the open position, the holding recess can receive the lowermost second screw 36 from the slot 70 of the magazine 34 into the position on top of the screwdriver bit 16 previously occupied by the first screw 32.

Upon release of the first screw 32 from the holding portion 30, the jaws 38, 38′ are urged together to trap a single second screw 36 in the holding recess on top of the screwdriver bit 16. Upon retraction of the screwdriver bit 16 from the holding recess, the jaws 38, 38′ are urged further together by spring 52 to the closed position, to trap the second screw 36 in the holding recess in the position previously occupied by the first screw 32. The second screw 36 can then be screwed into the workpiece as before by advancement of the screwdriver bit 16. These steps are repeated each time a screw is released from the holding recess.

The embodiment shown in the Figures has the advantage over the prior art of being significantly easier to use than the prior art, and being of more reliable and cost effective construction than the prior art, requiring fewer cooperating components.

It will be appreciated by persons skilled in the art that the above embodiment has been described by way of example only, and not in any limitative sense, and that various alterations and modifications are possible without departure from the scope of the invention as defined by the appended claims. For example, a hopper may be secured to the magazine 34 such that screws can be placed in the hopper in any orientation and can then be shaken or urged into position within the slot 70, recognising that the receiving portion 72 only permits insertion of a screw 36 into the slot 70 when it is properly aligned with the receiving portion 72, as explained above.

1. A screw feeder (10) adapted to be mounted to a screwdriver (12) and to hold screws (32,36) in position relative to a screwdriver bit (16) of the screwdriver (12) to assist insertion of the screws into a workpiece, the screw feeder comprising:-
a magazine (34) for containing a plurality of screws therewithin, the magazine including a first biasing means (74) to act upon screws therewithin;
a holding portion (30) in communication with the magazine (34), the holding portion (30) for releasably retaining screws (32,36) passed thereto from the magazine (34) and for releasing the screws releaseably retained therewithin under action of insertion of a screwdriver bit (16) into the holding portion in order to drive a screw held within the holding portion (30) into a workpiece;
wherein the holding portion (30) comprises at least one jaw (38) pivotable about a longitudinal axis (39), the at least one jaw arranged to releasably restrain a screw passed to the holding portion by the magazine under action of the first biasing means (74), the holding portion including a channel (50) within which channel a restrained screw is held until advanced out of the holding portion under action of the screwdriver bit (16) inserted into the holding portion via the channel (50 and into driving engagement with the screw so restrained;
and wherein the magazine (34) includes a central slot (70) along which central slot the screws pass under the action of the first biasing means (74), the central slot being aligned with the longitudinal axis of the pivotable at least one jaw (38) so that, on passing from the magazine to the holding portion, the screws maintain the same alignment relative to both the central slot (50) and the longitudinal axis (39);
and wherein screws from the magazine are fed in succession to the holding portion under action of the first biasing means and releasably restrained within the holding portion following retraction of said screwdriver bit (16) from said holding portion (30).

2. A screw feeder according to claim 1, wherein the first biasing means (74) urges screws (32,36) to be passed from the magazine (34) to the holding portion (38,38′) in a direction orthogonal to the longitudinal axis (39).

3. A screw feeder according to any one of the preceding claims, wherein said holding portion (30) comprises a plurality of jaws (38,38′) and defines at least one cam surface such that axial movement of a head of a screw (32,36) against the or each cam surface causes the jaws of the plurality of jaws (38,38′) to be urged apart.

4. A screw feeder according to any one of the preceding claims, further comprising guide means (56) adjacent said holding portion (30).

5. A screw feeder according to any one of the preceding claims wherein the central slot (70) comprises a respective screw head receiving portion.

6. A screw feeder according to any one of the preceding claims, wherein the holding portion (30) includes a second biasing means (52) for urging the at least one jaw member towards a position adapted to restrain a screw passed to the holding portion (30) from the magazine (34).

7. A screw feeder according to any one of the preceding claims, further comprising a mounting portion (18) for mounting said screw feeder to a screwdriver.

8. A screw feeder according to claim 7, further comprising adjustment means (24) for enabling adjustment of the separation of the mounting portion from the holding portion and the magazine.

9. A screw feeder according to claim 8, wherein the adjustment means comprises at least one telescopic arm (24).

10. A screw feeder according to claim 9, wherein the adjustment means further comprises third biasing means (25) for urging the mounting portion away from the holding portion and the magazine.

11. A screw feeder according to any one of claims 7 to 10, wherein the orientation of the holding portion and/or the magazine is adjustable relative to the mounting portion.

12. A screw feeder according to any one of the preceding claims wherein the magazine permits a slotted stacking of the screws for passing to the holding portion.

13. A screw feeder according to any one of the preceding claims wherein insertion of a screwdriver bit into the holding portion in order to advance a screw held therewithin causes movement of the at least one jaw member against the second biasing means, thereby to permit commencement of passing of a subsequent screw into the holding portion from the magazine.

14. A screw feeder according to any one of the preceding claims wherein screws within the magazine are not coupled to one another.

15. A screw feeder according to any one of the preceding claims wherein the slot (70) of the magazine (34) includes a screw head receiving portion (72) to permit insertion of screws (32,36) into the slot only in one orientation.

16. A power tool comprising:-
a body;
a screwdriver bit mounted to said body; and
a screw feeder according to any one of the preceding claims.
